(19) United States
(12) Patent Application Publication
(10) Pub. No.: US 2013/0225167 A1
(43) Pub. Date: Aug. 29, 2013

(54) METHOD AND APPARATUS FOR EXPANDING FEMTOCELL COVERAGE FOR HIGH CAPACITY OFFLOAD

(71) Applicant: QUALCOMM Incorporated, (US)

(72) Inventors: Yeliz Tokgoz, San Diego, CA (US); Mehmet Yavuz, San Diego, CA (US); Peerapol Tinnakornsrisuphap, San Diego, CA (US); Farhad Meshkati, San Diego, CA (US); Damanjit Singh, San Diego, CA (US); Sumeeth Nagaraja, San Diego, CA (US); Chirag S. Patel, San Diego, CA (US); Vinay Chande, San Diego, CA (US)

(73) Assignee: QUALCOMM Incorporated, San Diego, CA (US)

(21) Appl. No.: 13/772,099

(22) Filed: Feb. 20, 2013

Related U.S. Application Data
(60) Provisional application No. 61/602,838, filed on Feb. 24, 2012.

(51) Int. Cl. H04W 16/14

(52) U.S. Cl. CPC H04W 16/14
USPC 455/435.1; 455/452.1

(57) ABSTRACT

Systems and methods are provided for deploying a femto node with expanded coverage. This may be achieved, for example, by operating a femto node in an open or hybrid access mode to allow registration from both member and non-member devices, monitoring conditions on a backhaul link maintained with a wireless network over a broadband connection configured to provide internet access to the devices and to other devices operating independent of the femto node, and managing resources or mobility for each device based on whether the device is a member device or a non-member device and based on the conditions over on the backhaul link.

### CLAIM OF PRIORITY UNDER 35 U.S.C. §119

The present application for Patent claims the benefit of U.S. Provisional Application No. 61/602,838 entitled “METHOD AND APPARATUS FOR EXPANDING FEMTOCELL COVERAGE FOR HIGH CAPACITY OFFLOAD” filed Feb. 24, 2012, assigned to the assignee hereof, and expressly incorporated herein by reference.

### FIELD OF DISCLOSURE

This disclosure relates generally to telecommunications, and more particularly to femto cell base station management and the like.

### BACKGROUND

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, etc.). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

To supplement conventional base stations, additional low power base stations can be deployed to provide more robust wireless coverage to mobile devices. For example, low power base stations (commonly referred to as Home Node Bs or Home eNBs, collectively referred to as H(e)NBs, femto nodes, femtocell nodes, pico nodes, micro nodes, etc.) can be deployed for incremental capacity growth, richer user experience, in-building or other specific geographic coverage, and the like. In some configurations, such low power base stations are connected to the Internet via broadband connection (e.g., digital subscriber line (DSL) router, cable or other modem, etc.), which can provide the backhaul link to the mobile operator's network. In this regard, low power base stations are often deployed in homes, offices, etc. without consideration of a current network environment.

Demand for data in cellular networks is increasing exponentially, and the trend is expected to continue. The frequency spectrum allocated for such device communication is limited, however, such that solutions requiring expansion of the spectrum may not be feasible.

### SUMMARY

Example embodiments of the invention are directed to systems and methods for deploying femto nodes with expanded coverage.

In some embodiments, a method is provided for deploying a femto node with expanded coverage. The method may comprise, for example: operating a femto node in an open or hybrid access mode to allow registration from both member and non-member devices; monitoring conditions on a backhaul link maintained with a wireless network over a broadband connection configured to provide internet access to the devices and to other devices operating independent of the femto node; and managing resources or mobility for each device based on whether the device is a member device or a non-member device and based on the conditions over on the backhaul link.

In other embodiments, an apparatus is provided for deploying a femto node with expanded coverage. The apparatus may comprise, for example, at least one processor configured to: operate a femto node in an open or hybrid access mode to allow registration from both member and non-member devices, monitor conditions on a backhaul link maintained with a wireless network over a broadband connection configured to provide internet access to the devices and to other devices operating independent of the femto node, and manage resources or mobility for each device based on whether the device is a member device or a non-member device and based on the conditions over on the backhaul link. The apparatus may accordingly also comprise, for example, memory coupled to the at least one processor.

In still other embodiments, another apparatus is provided for deploying a femto node with expanded coverage. The apparatus may comprise, for example: means for operating a femto node in an open or hybrid access mode to allow registration from both member and non-member devices; means for monitoring conditions on a backhaul link maintained with a wireless network over a broadband connection configured to provide internet access to the devices and to other devices operating independent of the femto node; and means for managing resources or mobility for each device based on whether the device is a member device or a non-member device and based on the conditions over on the backhaul link.

In still other embodiments, a computer-readable medium is provided comprising code, which, when executed by at least one processor, causes the at least one processor to perform operations for deploying a femto node with expanded coverage. The computer-readable medium may comprise, for example: code for operating a femto node in an open or hybrid access mode to allow registration from both member and non-member devices; code for monitoring conditions on a backhaul link maintained with a wireless network over a broadband connection configured to provide internet access to the devices and to other devices operating independent of the femto node; and code for managing resources or mobility for each device based on whether the device is a member device or a non-member device and based on the conditions over on the backhaul link.

### BRIEF DESCRIPTION OF THE DRAWINGS

The accompanying drawings are presented to aid in the description of embodiments of the invention and are provided solely for illustration of the embodiments and not limitation thereof.

FIG. 1 is a block diagram of an example system that facilitates offloading devices to a femto node by expanding coverage thereof.

FIG. 2 is a block diagram of an example system that facilitates expanding coverage of a femto node.

FIG. 3 is a flow chart of an aspect of an example methodology for managing resources and mobility of a femto node with expanded coverage.

FIG. 4 is a block diagram of an example system that manages resources and mobility of a femto node with expanded coverage.

FIG. 5 is a block diagram of an example wireless communication system in accordance with various aspects set forth herein.

FIG. 6 is an illustration of an example wireless network environment that can be employed in conjunction with the various systems and methods described herein.

FIG. 7 illustrates an example wireless communication system, configured to support a number of devices, in which the aspects herein can be implemented.

FIG. 8 is an illustration of an exemplary communication system to enable deployment of femtocells within a network environment.

FIG. 9 illustrates an example of a coverage map having several defined tracking areas.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As described further herein, low power base stations, such as femto nodes, can be expanded to provide coverage beyond that conventionally intended, resulting in densification of a wireless network. In this way, access points may be brought effectively closer to devices, improving signal quality for communications therewith. Moreover, the number of users sharing a given access point can be reduced, which allows a given device to utilize a higher percentage of airlink resources with the access point. Thus, for example, low power base stations intended for residential use can operate in an open, or at least hybrid, access mode (as opposed to a closed access mode) to allow nearby devices to connect thereto, which can help to offload a neighboring access point (e.g., a low power base station or macro base station). Stated another way, where low power base stations are typically intended to provide coverage in a home or other indoor setting for one or more users, the coverage can be expanded outdoors to users otherwise not intended to be covered by operating in a hybrid or open access mode. In addition, low power base stations can be deployed in other areas for the purpose of providing further densification.

To configure the low power access points for expanding coverage, additional considerations are discussed herein with respect to mobility among the access points, resource management, etc. For example, when a device reselects to a low power access point, the device can register therewith for receiving paging signals, or the low power base station can be present in a set of nodes for paging the device. In another example, where a device is in an active call, soft handover can be utilized to ensure at least one low power base station is available as an anchor for the call. Moreover, for example, a low power base station can manage resources so as to prefer high priority devices (e.g., devices associated with the owner of the low power base station) when bandwidth or the airlink becomes constricted. In any case, expanding the coverage of low power base stations can allow devices to handover from a macro base station or another low power base station to provide increased offloading, and thus improved user experience. Moreover, by using existing deployment models for expanding coverage, internet ports at customer homes may be leveraged for a backhaul connection, which lessens costs associated with other coverage expansion possibilities, such as adding new macro nodes or adding new carriers to existing macro nodes.

A low power base station, as referenced herein, can include a femto node, a pico node, micro node, home Node B or home evolved Node B (H(e)NB), relay, and/or other low power base stations, and can be referred to herein using one of these terms, though use of these terms is intended to generally encompass low power base stations. In general, a low power base station is referred to as such because it transmits at a relatively low power as compared to a macro base station associated with a wireless wide area network (WWAN). Accordingly, the coverage area of the low power base station is typically substantially smaller than the coverage area of a macro base station.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, communication device, user agent, user device, or user equipment (UE). A wireless terminal or device may be a cellular telephone, a satellite phone, a cordless telephone, a Session Initiation Protocol (SIP) phone, a wireless local loop (WLL) station, a personal digital assistant (PDA), a handheld device having wireless connection capability, a tablet, a computing device, or other processing devices connected to a wireless modem. Various aspects are also described herein in connection with a base station. A base station may be utilized for communicating with wireless terminal(s) and may also be referred to as an access point, a Node B, evolved Node B (eNB), home Node B (HNB) or home evolved Node B (HeNB), collectively referred to as H(e)NB, or some other terminology.

In general, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA, WiFi carrier sense multiple access (CSMA), and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc., and/or may not include all of the devices, components, modules etc. discussed in connection with the figures. A combination of these approaches may also be used.

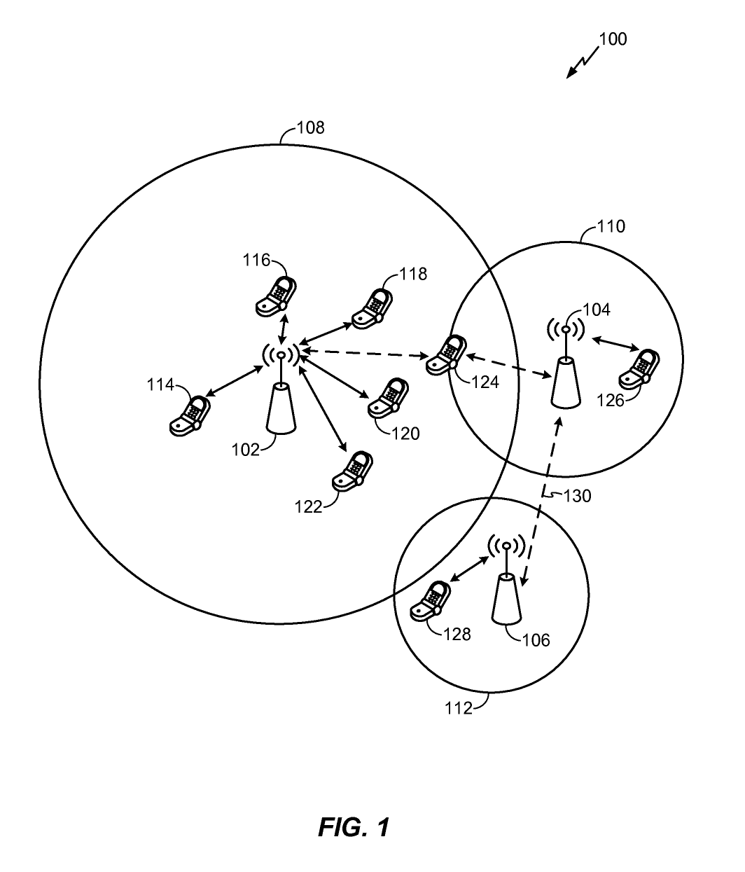

Referring to FIG. 1, an example wireless communication system 100 is illustrated that facilitates expanding coverage of a femto node. System 100 comprises a macro node 102, which can be a macro base station or a femto, pico, or other low power base station node, in one example. System 100 also includes femto nodes 104 and 106, which can be substantially any type of low power base station or at least a portion thereof. The nodes 102, 104, and 106 provide respective coverage areas 108, 110, and 112. System 100 also includes a plurality of devices 114, 116, 118, 120, 122, 124, 126, and 128 that communicate with the nodes 102, 104, or 106 to receive wireless network access.

As described, the femto nodes 104 and 106 can communicate with the wireless network (not shown) over a broadband connection. In addition, femto nodes 104 and 106 can communicate with one another, and/or with macro node 102, over a backhaul connection. For example, upon initialization, one or more of the femto nodes 104 and/or 106 can also communicate with one another to form a grouping (e.g., an ad-hoc network). This allows the femto nodes 104 and/or 106 to communicate to determine parameters related to serving the various devices connected thereto (e.g., resource allocations, interference management, and/or the like), in one example. Moreover, femto nodes 104 and 106 can automatically configure themselves to operate in the wireless network (e.g., set transmit power, network identifiers, pilot signal resources, and/or the like based on similar information received over a backhaul connection, over-the-air, or otherwise sensed from surrounding nodes). In this example, the femto nodes 104 and 106 can behave as plug-and-play devices requiring little user interaction to be provisioned on the wireless network.

In some designs, femto node 104 can operate in an open or hybrid access mode to offload device 124 from macro node 102 since device 124 is in range of femto node 104. In a conventional system, for example, femto node 104 may have operated in a closed access mode restricting access only to devices in a closed subscriber group (CSG) associated with femto node 104, such as device 126. Thus, device 124 previously may not have had access to femto node 104. In examples described herein, femto node 104 may expand its coverage and start operating in an open access mode (e.g., allowing full access to device 124 and/or other non-member devices) or a hybrid access mode (e.g., providing at least some level of access to device 124 and/or other non-member devices) such that device 124 can reselect from macro node 102 to femto node 104 when in range.

Moreover, various femto nodes, such as femto nodes 104 and 106, can operate in a group and/or be associated with a femto node management server (e.g., an HeNB gateway) that manages resource allocation, interference management, etc., between the femto nodes 104 and/or 106. For example, femto nodes 104 and 106 can associate and communicate (e.g., via a management server of a core wireless network or directly) over a backhaul link 130. As described further herein, mobility and/or resources of the femto node 104 and/or 106 can be managed within the group (e.g., using the management server or otherwise).

The femto nodes 104 and 106 can support seamless mobility therebetween, and/or with macro node 102. For example, device 124 can move towards femto node 106 and can reselect thereto when within range (e.g., where femto node 106 provides open or hybrid access). In this example, device 124 can still be reachable for incoming calls by registering with the femto node 106 to receive paging signals therefrom, by the femto node 106 being in a set of nodes to be paged when device 124 receives a call, and/or the like.

Where device 124 communicates in connected mode with femto node 104, for example, device 124 can continue a call without interruption when reselecting to femto node 106. In one example, to facilitate this behavior, device 124 can soft handover to femto node 106 while keeping femto node 104 as an anchor for the call. In another example, device 124 can hard handover from femto node 104 to femto node 106 when within a requisite range. Similarly, the device 124 can handover to macro node 102 where femto coverage degrades (e.g., due to device mobility, a presence of interference, or otherwise). In another example, where device 124 is in a location such that it is handed over between femto nodes 104 and 106 frequently (e.g., n times within a period of time), device 124 can reselect to macro node 102, and/or be handed over thereto by femto node 104 or 106, for more stable service.

In addition, femto node 104 can prioritize resource assignment for devices communicating therewith. In one example, a user of the femto node 104 is also associated with device 126, and thus this device 126 can receive resources at a higher priority than other devices communicating with femto node 104 as a result of the expanded coverage, such as device 124. In an example, femto node 104 can give priority to device 126 for resource allocation in certain situations. For instance, femto node 104 can allocate more resources to device 126 than to other devices, such as device 124, where femto node 104 is experiencing backhaul connectivity limitations or if the airlink on femto node 104 is loaded beyond a threshold. In these cases where femto node 104 is running out of channel elements, femto node 104 can handover one or more of the other devices, such as device 126, to another femto node or macro node 102.

In another example, femto node 104 can allow femto traffic to generally only occupy a certain portion of an available backhaul link to yield to other internet traffic at the place where the femto node 104 resides. Moreover, in one example, femto node 104 can allocate resources to devices and determine whether to handover devices to ensure devices are at a best system at a given time (e.g., the node that provides the device with the best user experience in terms of throughput, application performance, reliability, etc.). For example, this can correspond to an analysis of one or more parameters as compared to one another and/or to one or more thresholds.

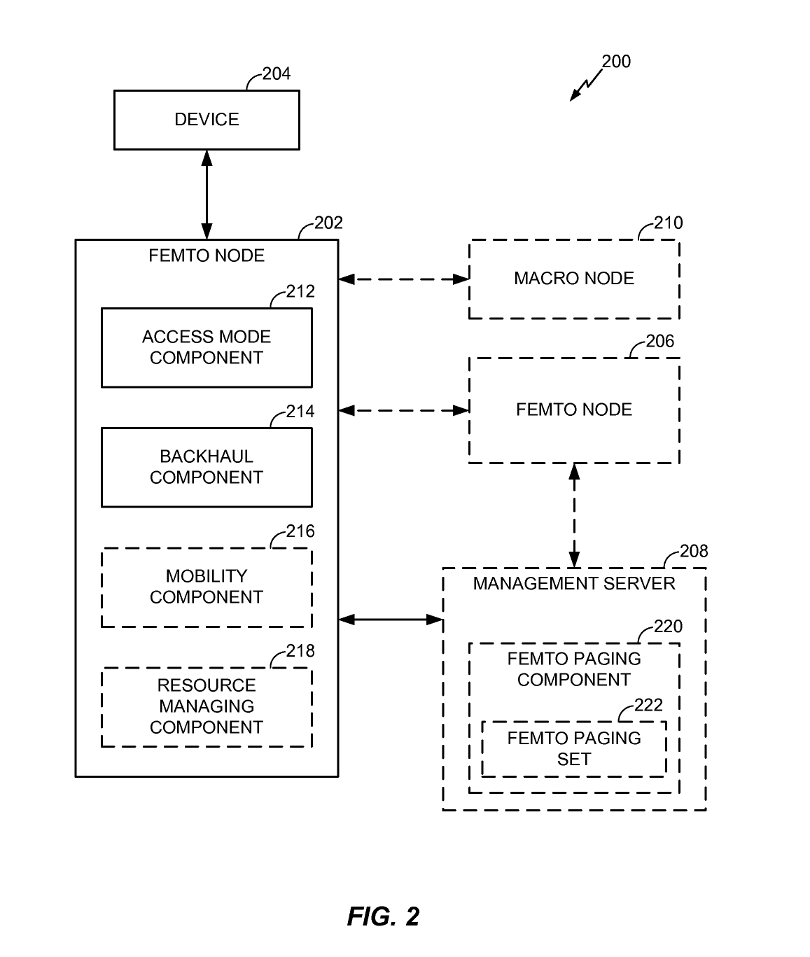

FIG. 2 illustrates an example system 200 for expanding coverage of a femto node. System 200 comprises a femto node 202 that provides wireless network access to a device 204, as described, as well as a femto node 206 that is near femto node 202. Femto nodes 202 and 206 can participate in an ad-hoc network, as described, to manage access provided to one or more devices, such as device 204. Thus, for example, femto node 202 can be similar to one of femto nodes 104 or 106, and femto node 206 can be similar to another one of femto nodes 104 or 106. In this example, femto nodes 202 and 206 can communicate over a backhaul or optionally through a management server 208 to manage parameters related to providing network access to the devices. As described, device 204 can be similar to one of devices 114, 116, 118, 120, 122, 124, 126, and/or 128, and can be a UE, modem (or other tethered device), a portion thereof, etc. Moreover, an optional macro node 210 is provided from which device 204 can be handed over to femto node 202 and/or to which femto node 202 can handover device 204. Macro node 210 can be similar to macro node 102, in one example.

Femto node 202 can include an access mode component 212 for communicating using at least one of a closed, open, or hybrid access mode over an air interface with one or more devices, and a backhaul component 214 for communicating with one or more core network components, such as a management server, and/or other femto nodes or macro nodes. In doing so, the backhaul component 214 may monitor conditions on the backhaul link. Femto node 202 also optionally includes a mobility component 216 for providing mobility for a device among various femto nodes, and/or a resource managing component 218 for allocating resources to one or more devices communicating with the femto node 202.

Management server 208 includes a femto paging component 220 that can cause one or more femto nodes to send paging signals to an idle mode device.

According to an example, access mode component 212 can operate femto node 202 in an open or hybrid access mode, as described. When operating in an open access mode, femto node 202 can provide similar access to all devices regardless of membership in a CSG related to femto node 202. In a hybrid access mode, femto node 202 can provide a level of service to member devices (devices in the CSG), while providing another level of service (e.g., a more restricted level) to non-member devices (devices not in the CSG), such as a level of service allowing voice calls only, having limited data rate or amount, advertising an ability to purchase additional data rate services or join the CSG, etc. In any case, however, non-member devices can receive at least some access from the femto node 202. In an example, access mode component 212 can advertise the access mode in which the femto node 202 operates (e.g., in an overhead system information message).

Backhaul component 214, as described, can communicate with core network components over a broadband connection thereto, and, in some designs, monitor conditions on the backhaul link. Femto node 202 can provide devices with access to the core network over the connection maintained by backhaul component 214, in this regard. By opening access of femto node 202, as described, more devices, such as device 204, can offload from a nearby macro node or femto node, such as macro node 210 or femto node 206, to provide improved network capacity. In this regard, device 204 can be a non-member device.

In one example, device 204 can be handed over from macro node 210, or femto node 206, to femto node 202. Mobility component 216 can allow device 204 to receive paging signals from femto node 202. For example, mobility component 216 can receive a registration request from device 204 as part of the mobility procedure (e.g., idle-mode reselection), and can accordingly establish paging resources for device 204. In another example, femto paging component 220 can include substantially all femto nodes 202 in a network or otherwise associated with management server 208 in femto paging set 222. The femto paging set 222 can be device specific, in one example, and management server 208 can consult the set to determine femto nodes that can page a given device, such as device 204, when a call is received in the core network. In other systems where the device 204 typically does not have access to some femto nodes, femto paging set 222 may not include such femto nodes in the paging set. In these examples, however, the femto nodes that operate in open and/or hybrid access mode to expand network coverage can be added to femto paging set 222 for device 204.

In addition, where device 204 is in an active call when handed over to femto node 202, device 204 can continue the call without interruption. In one example, device 204 can soft handover to femto node 202 such to have an anchor node (e.g., the node from which the soft handover is initiated) for the call. In this example, if handover fails or the femto node 202 is otherwise unable to provide the device 204 with a level of service, the device 204 can continue the call with the anchor node. For example, where device 204 is handed over from femto node 202 to another node while in the call, mobility component 216 can operate femto node 202 as the anchor node. In other examples, mobility component 216 can perform a hard handover of device 204 to another node, such as femto node 206 or macro node 210 depending on measurement reports received from device 204 (e.g., whichever node has better signal strength measurements).

Moreover, in an example, mobility component 216 can handover device 204 to macro node 210 where mobility component 216 determines that the device 204 is handed over between femto node 202 and femto node 206 over a threshold number of times within a threshold time period (e.g., to avoid constant handover). It is to be appreciated that femto node 202 and macro node 210 (e.g., and/or femto node 206) can correspond to the same operator and/or communicate according to roaming agreements to facilitate mobility of device 204.

In another example, resource managing component 218 can manage resource allocation to device 204 based on one or more considerations. For example, resource managing component 218 can provide higher priority to traffic of the owner of the femto node 202 than to device 204, which can be owned by someone else. In this example, resource managing component 218 can allow traffic received from device 204 or other devices to occupy a portion of backhaul link, to allow at least a minimum throughput for the rest of the internet traffic. In another example, resource managing component 218 can allocate more resources to high priority devices (e.g., devices owned by the owner of femto node 202) rather than to device 204, where resource managing component 218 determines limitations at the backhaul link, loading beyond a threshold at an airlink, etc. Moreover, for example, where channel elements available at femto node 202 are below a threshold, resource managing component 218 can use mobility component 216 to handover device 204 to another femto node 206 or macro node 210 to give way for devices owned by the owner of femto node 202.

In another example, resource managing component 218 can cause handover of device 204 based on determining that femto node 206 or macro node 210 can provide improved communication metrics for device 204 (e.g., throughput, application performance, reliability, etc.). In one example, this can be based on measurements reported by the device 204, known throughput for device 204 at femto node 202 (e.g., based on feedback from device 204, known modifications to resources allocated to device 204, etc.), and/or the like.

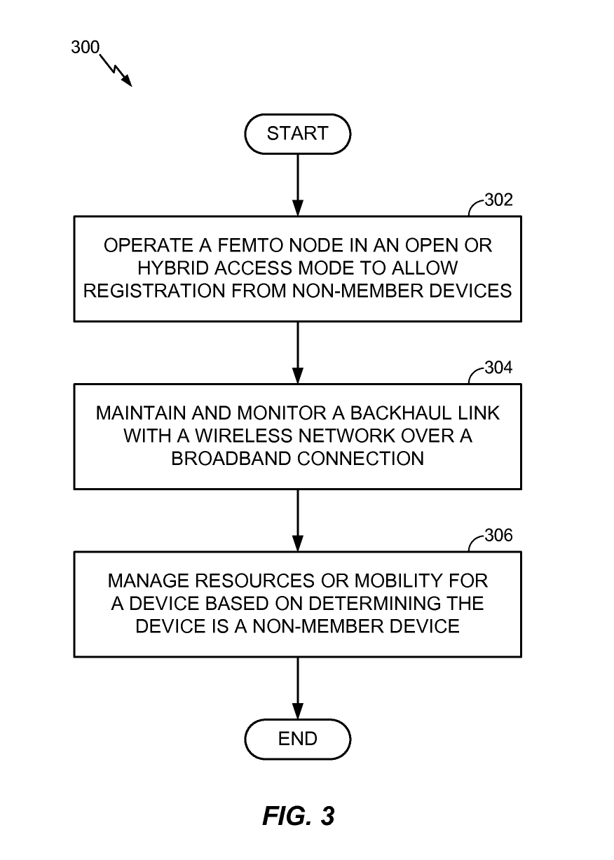

Referring to FIG. 3, an example methodology relating to expanding coverage of femto nodes is illustrated. While, for purposes of simplicity of explanation, methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Turning to FIG. 3, an example methodology 300 is displayed that facilitates expanding coverage area of a femto node.

At 302, a femto node is operated in an open or hybrid access mode to allow registration from both member and non-member devices. In an example, the access mode can be advertised by the femto node to allow devices to determine whether access is allowed. As described, femto nodes previously closed and reserved for residential use can be expanded to operate in an open or hybrid access mode to provide service to other devices, allowing for densification and improved user experience in a wireless network. Accordingly, it will be appreciated that the femto node may be operated so as to allow registration for at least one device located in a separate residence or outdoors as compared to the femto node, such that the expanded coverage provides coverage for both indoor and outdoor devices.

At 304, a backhaul link can be maintained with a wireless network over a broadband connection configured to provide internet access to both the member and the non-member devices (as well as to other devices operating independent of the femto node), and conditions on the backhaul link can be monitored. In this regard, the broadband connection setup for the femto node may be leveraged to provide the expanded coverage for the femto node, which can decrease deployment costs for effective expansion of the wireless network. In some cases, however, limitations may be desired on the resources assigned to non-member devices that are not associated with the user providing the femto node, as described below.

At 306, resources or mobility for a device can be managed based on determining the device is a non-member device. For example, resources can be allocated to the non-member device while ensuring a minimum throughput for other devices or applications over the broadband connection (e.g., a computer, digital video recorder, or other home networked devices associated with the user of the femto node and sharing the broadband connection therewith). In addition, resources can be allocated to the non-member device while preferring resource allocation to a member device where the backhaul or airlink is limited. Moreover, managing the resources can include handing over the non-member device where available channel elements at the femto node are below a threshold level.

Accordingly, it will be appreciated that managing resources or mobility for each device may be based on whether the device is a member device or a non-member device and based on the conditions on the backhaul link. For example, managing the resources or mobility for each device may comprise prioritizing resource allocation for member devices as compared to resource allocation for non-member devices when the conditions on the backhaul link fall below a threshold. In another example, managing the resources or mobility for each device may comprise causing a non-member device to be handed over to another node when the conditions on the backhaul link fall below a threshold. Handing over the device may be further based on whether the device is in an active call with the femto node and moving to the coverage area of the other node. In still another example, managing the resources or mobility for each device may comprise limiting resource allocation for the femto node over the broadband connection based on a throughput requirement for other internet traffic sharing the broadband connection.

In addition, at 306, mobility can be managed by providing soft handover of a non-member device in an active call with the femto node to maintain an anchor node, as described. Moreover, a non-member device experiencing frequent handover between the femto node and another femto node (e.g., a threshold number of handovers in a specified period of time) can be handed over to a macro node for improved reliability. In addition, managing mobility at 306 can include handing over the non-member device where it is determined that another node can provide improved performance and device experience, as described. Accordingly, it will be appreciated frequent handover of a device between the femto node and another femto node may be detected, such that managing the resources or mobility for the device may comprise causing the device to handover to a macro node based on the detected frequent handover.

It will be appreciated that, in accordance with one or more aspects described herein, inferences can be made regarding determining a resource allocation for a non-member device, determining whether and how to handover the non-member device, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

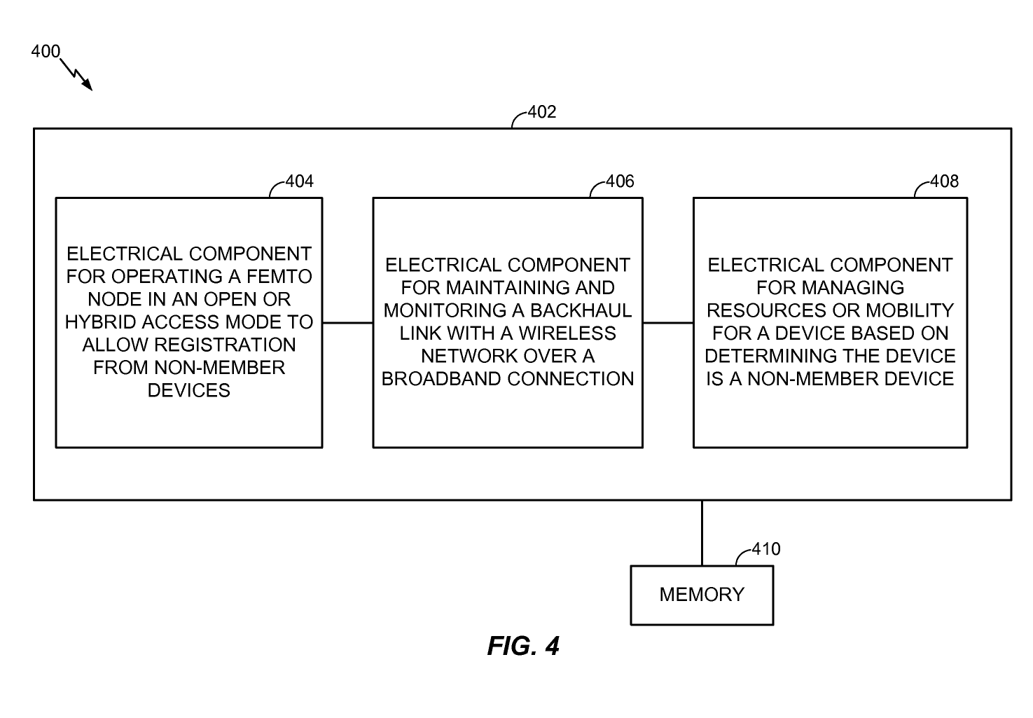

With reference to FIG. 4, illustrated is a system 400 for expanding coverage area of a femto node. For example, system 400 can reside at least partially within a femto node. It is to be appreciated that system 400 is represented as including functional blocks, which can be functional blocks that represent functions implemented by a processor, software, or combination thereof (e.g., firmware). System 400 includes a logical grouping 402 of electrical components that can act in conjunction. For instance, logical grouping 402 can include an electrical component for operating a femto node in an open or hybrid access mode to allow registration from non-member devices 404. Further, logical grouping 402 can comprise an electrical component for maintaining a backhaul link with a wireless network over a broadband connection to provide access to the non-member devices 406.

Further, logical grouping 402 can include an electrical component for managing resources or mobility for a device based on determining the device is a non-member device 408. As described, this can include managing resources to prefer other devices associated with a user of the femto node, managing mobility to prevent ping-ponging between two femto nodes, etc. For example, electrical component 404 can include an access mode component 212, as described above. In addition, for example, electrical component 406, in an aspect, can include a backhaul component 214, as described above. Moreover, electrical component 408 can include a mobility component 216, resource managing component 218, and/or the like, for example.

Additionally, system 400 can include a memory 410 that retains instructions for executing functions associated with the electrical components 404, 406, and 408. While shown as being external to memory 410, it is to be understood that one or more of the electrical components 404, 406, and 408 can exist within memory 410. In one example, electrical components 404, 406, and 408 can comprise at least one processor, or each electrical component 404, 406, and 408 can be a corresponding module of at least one processor. Moreover, in an additional or alternative example, electrical components 404, 406, and 408 can be a computer program product comprising a computer readable medium, where each electrical component 404, 406, and 408 can be corresponding code.

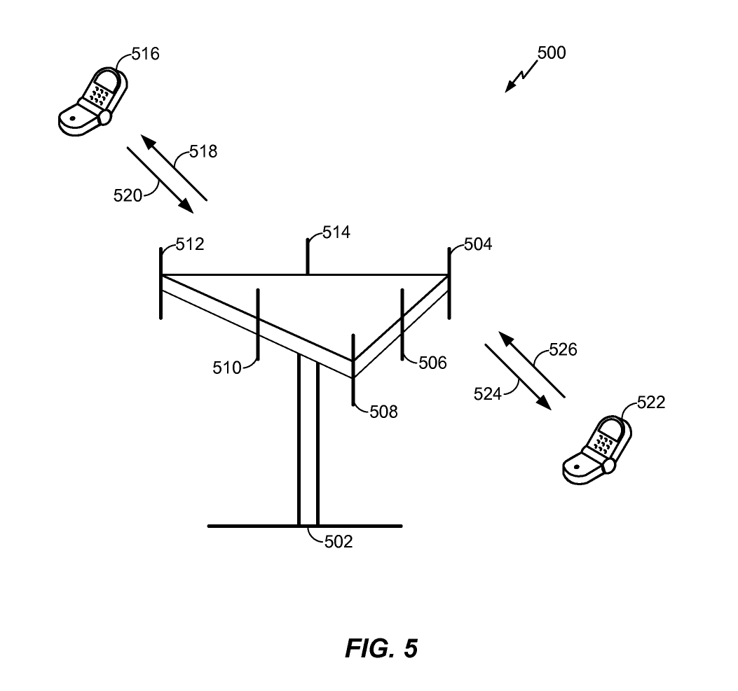

Referring now to FIG. 5, a wireless communication system 500 is illustrated in accordance with various embodiments presented herein. System 500 comprises a base station 502 that can include multiple antenna groups. For example, one antenna group can include antennas 504 and 506, another group can comprise antennas 508 and 510, and an additional group can include antennas 512 and 514. Two antennas are illustrated for each antenna group; however, more or fewer antennas can be utilized for each group. Base station 502 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated.

Base station 502 can communicate with one or more mobile devices such as mobile device 516 and mobile device 522; however, it is to be appreciated that base station 502 can communicate with substantially any number of mobile devices similar to mobile devices 516 and 522. Mobile devices 516 and 522 can be, for example, cellular phones, smart phones, laptops, handheld communication devices, handheld computing devices, satellite radios, global positioning systems, PDAs, and/or any other suitable device for communicating over wireless communication system 500. As depicted, mobile device 516 is in communication with antennas 512 and 514, where antennas 512 and 514 transmit information to mobile device 516 over a forward link 518 and receive information from mobile device 516 over a reverse link 520. Moreover, mobile device 522 is in communication with antennas 504 and 506, where antennas 504 and 506 transmit information to mobile device 522 over a forward link 524 and receive information from mobile device 522 over a reverse link 526. In a frequency division duplex (FDD) system, forward link 518 can utilize a different frequency band than that used by reverse link 520, and forward link 524 can employ a different frequency band than that employed by reverse link 526, for example. Further, in a time division duplex (TDD) system, forward link 518 and reverse link 520 can utilize a common frequency band and forward link 524 and reverse link 526 can utilize a common frequency band.

Each group of antennas and/or the area in which they are designated to communicate can be referred to as a sector of base station 502. For example, antenna groups can be designed to communicate to mobile devices in a sector of the areas covered by base station 502. In communication over forward links 518 and 524, the transmitting antennas of base station 502 can utilize beamforming to improve signal-to-noise ratio of forward links 518 and 524 for mobile devices 516 and 522. Also, while base station 502 utilizes beamforming to transmit to mobile devices 516 and 522 scattered randomly through an associated coverage, mobile devices in neighboring cells can be subject to less interference as compared to a base station transmitting through a single antenna to all its mobile devices. Moreover, mobile devices 516 and 522 can communicate directly with one another using a peer-to-peer or ad hoc technology as described. According to an example, system 500 can be a multiple-input multiple-output (MIMO) communication system.

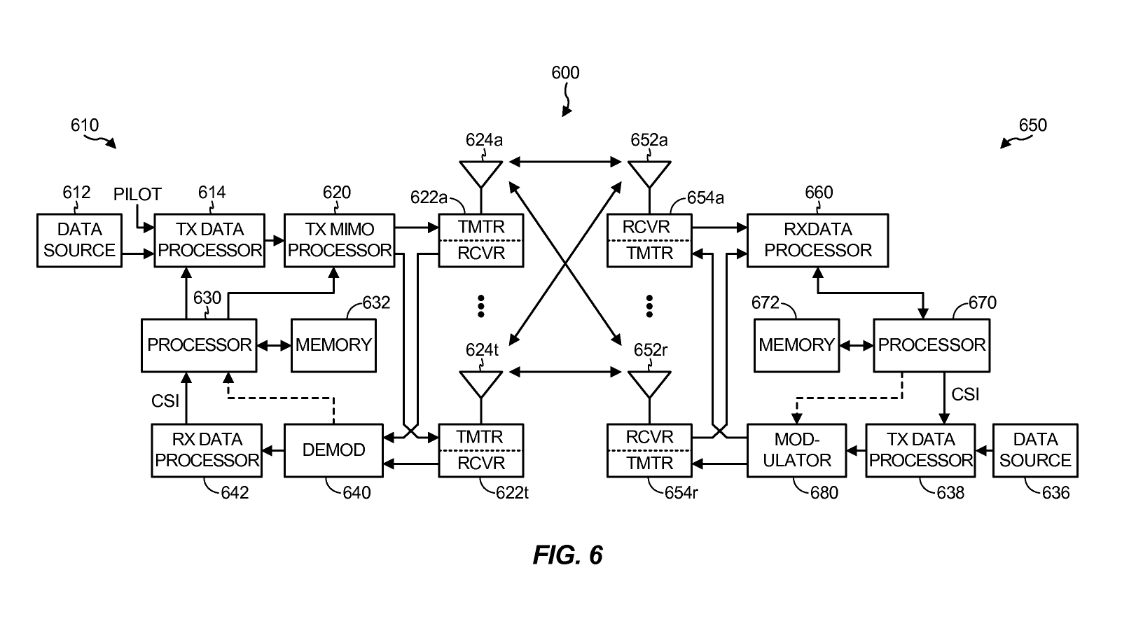

FIG. 6 shows an example wireless communication system 600. The wireless communication system 600 depicts one base station 610, which can include a femto node, and one mobile device 650 for sake of brevity. However, it is to be appreciated that system 600 can include more than one base station and/or more than one mobile device, wherein additional base stations and/or mobile devices can be substantially similar or different from example base station 610 and mobile device 650 described below. In addition, it is to be appreciated that base station 610 and/or mobile device 650 can employ the systems (FIGS. 1, 2, 4, and 5) and/or methods (FIG. 3) described herein to facilitate wireless communication therebetween. For example, components or functions of the systems and/or methods described herein can be part of a memory 632 and/or 672 or processors 630 and/or 670 described below, and/or can be executed by processors 630 and/or 670 to perform the disclosed functions.

At base station 610, traffic data for a number of data streams is provided from a data source 612 to a transmit (TX) data processor 614. According to an example, each data stream can be transmitted over a respective antenna. TX data processor 614 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 650 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 630.

The modulation symbols for the data streams can be provided to a TX MIMO processor 620, which can further process the modulation symbols (e.g., for OFDM). TX MIMO processor 620 then provides NT modulation symbol streams to NT transmitters (TMTR) 622a through 622t. In various embodiments, TX MIMO processor 620 applies beamforming weights to the symbols of the data streams and to the antenna from which the symbol is being transmitted.

Each transmitter 622 receives and processes a respective symbol stream to provide one or more analog signals, and further conditions (e.g., amplifies, filters, and upconverts) the analog signals to provide a modulated signal suitable for transmission over the MIMO channel. Further, NT modulated signals from transmitters 622a through 622t are transmitted from NT antennas 624a through 624t, respectively.

At mobile device 650, the transmitted modulated signals are received by NR antennas 652a through 652r and the received signal from each antenna 652 is provided to a respective receiver (RCVR) 654a through 654r. Each receiver 654 conditions (e.g., filters, amplifies, and downconverts) a respective signal, digitizes the conditioned signal to provide samples, and further processes the samples to provide a corresponding “received” symbol stream.

An RX data processor 660 can receive and process the NR received symbol streams from NR receivers 654 based on a particular receiver processing technique to provide NT “detected” symbol streams. RX data processor 660 can demodulate, deinterleave, and decode each detected symbol stream to recover the traffic data for the data stream. The processing by RX data processor 660 is complementary to that performed by TX MIMO processor 620 and TX data processor 614 at base station 610.

The reverse link message can comprise various types of information regarding the communication link and/or the received data stream. The reverse link message can be processed by a TX data processor 638, which also receives traffic data for a number of data streams from a data source 636, modulated by a modulator 680, conditioned by transmitters 654a through 654r, and transmitted back to base station 610.

At base station 610, the modulated signals from mobile device 650 are received by antennas 624, conditioned by receivers 622, demodulated by a demodulator 640, and processed by a RX data processor 642 to extract the reverse link message transmitted by mobile device 650. Further, processor 630 can process the extracted message to determine which precoding matrix to use for determining the beamforming weights.

Processors 630 and 670 can direct (e.g., control, coordinate, manage, etc.) operation at base station 610 and mobile device 650, respectively. Respective processors 630 and 670 can be associated with memory 632 and 672 that store program codes and data. Processors 630 and 670 can also perform functionalities described herein to support expanding coverage area of one or more femto nodes.

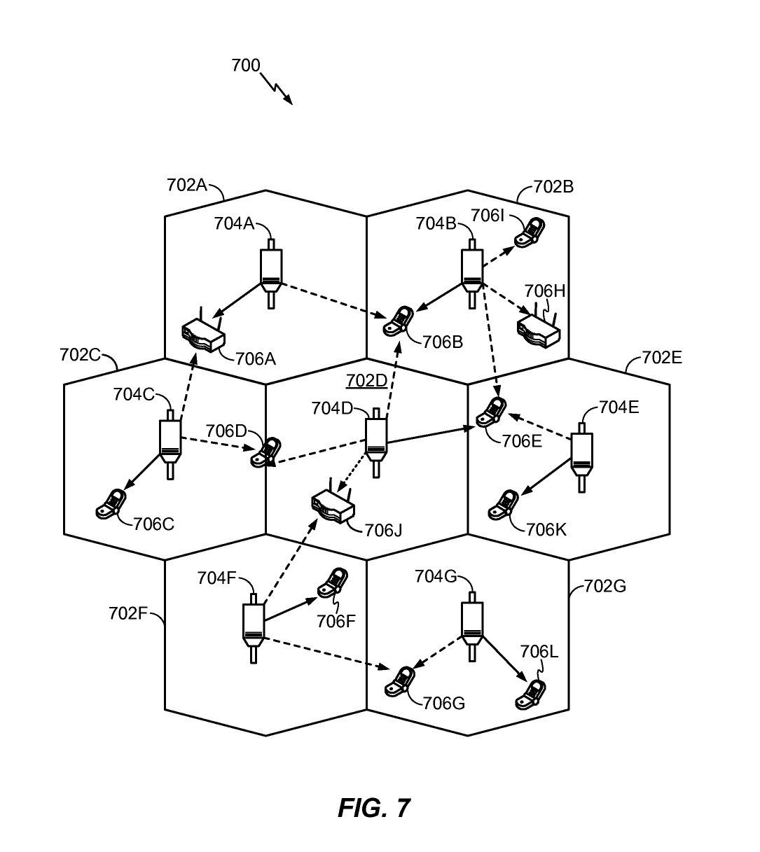

FIG. 7 illustrates a wireless communication system 700, configured to support a number of users, in which the embodiments and teachings herein may be implemented. The system 700 provides communication for multiple cells 702, such as, for example, macro cells 702A-702G, with each cell being serviced by a corresponding access node 704 (e.g., access nodes 704A-704G). As shown in FIG. 7, access terminals 706 (e.g., access terminals 706A-706L) can be dispersed at various locations throughout the system over time. Each access terminal 706 can communicate with one or more access nodes 704 on a forward link (FL) and/or a reverse link (RL) at a given moment, depending upon whether the access terminal 706 is active and whether it is in soft handoff, for example. The wireless communication system 700 can provide service over a large geographic region.

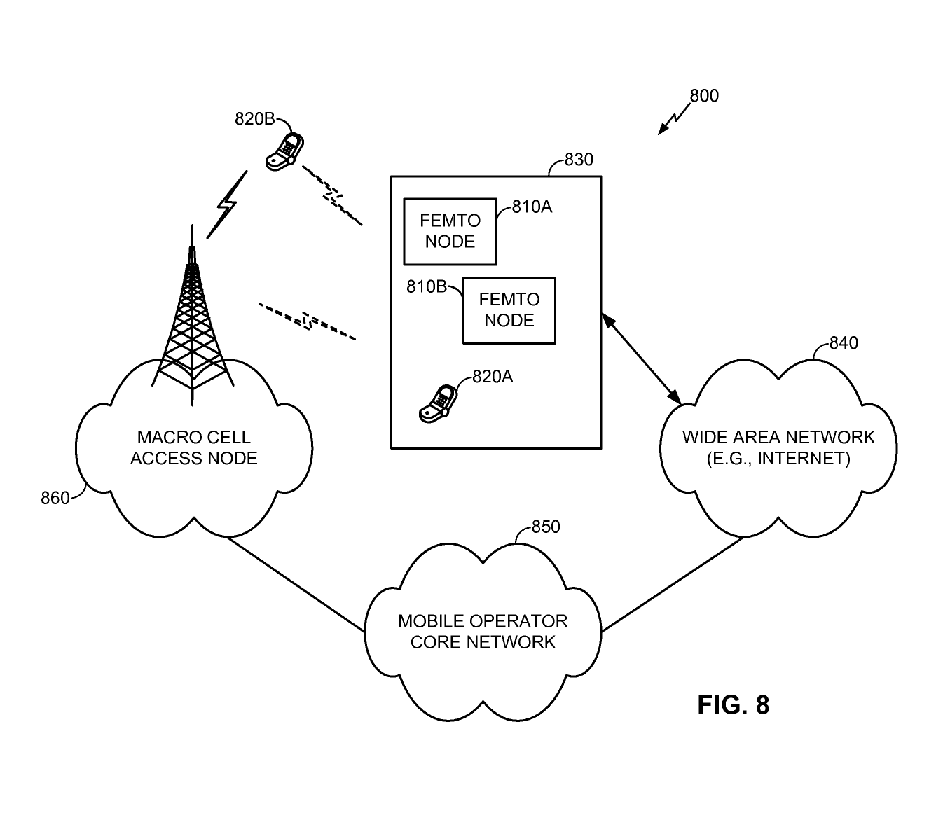

FIG. 8 illustrates an exemplary communication system 800 where one or more femto nodes are deployed within a network environment. Specifically, the system 800 includes multiple femto nodes 810A and 810B (e.g., femtocell nodes or H(e)NB) installed in a relatively small scale network environment (e.g., in one or more user residences 830). Each femto node 810 can be coupled to a wide area network 840 (e.g., the Internet) and a mobile operator core network 850 via a digital subscriber line (DSL) router, a cable modem, a wireless link, or other connectivity means (not shown). As will be discussed below, each femto node 810 can be configured to serve associated access terminals 820 (e.g., access terminal 820A) and, optionally, alien access terminals 820 (e.g., access terminal 820B). In other words, access to femto nodes 810 can be restricted such that a given access terminal 820 can be served by a set of designated (e.g., home) femto node(s) 810 but may not be served by any non-designated femto nodes 810 (e.g., a neighbor's femto node).

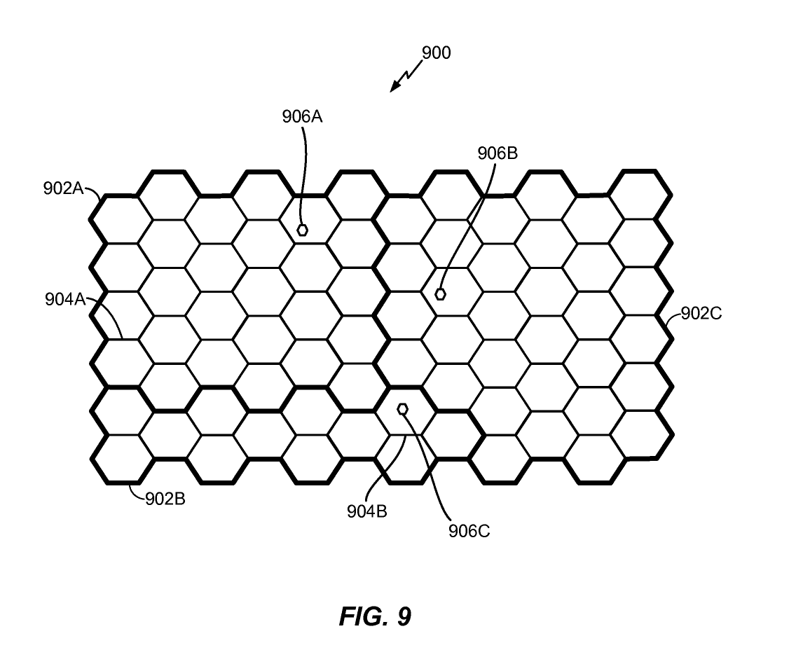

FIG. 9 illustrates an example of a coverage map 900 where several tracking areas 902 (or routing areas or location areas) are defined, each of which includes several macro coverage areas 904. Here, areas of coverage associated with tracking areas 902A, 902B, and 902C are delineated by the wide lines and the macro coverage areas 904 (e.g., 904A and 904B) are represented by the hexagons. The tracking areas 902 also include femto coverage areas 906 (e.g., 906A, 906B, and 906C). In this example, each of the femto coverage areas 906 (e.g., femto coverage area 906C) is depicted within a macro coverage area 904 (e.g., macro coverage area 904B). It should be appreciated, however, that a femto coverage area 906 may not lie entirely within a macro coverage area 904. In practice, a large number of femto coverage areas 906 can be defined with a given tracking area 902 or macro coverage area 904. Also, one or more pico coverage areas (not shown) can be defined within a given tracking area 902 or macro coverage area 904.

Referring again to FIG. 8, the owner of a femto node 810 can subscribe to mobile service, such as, for example, 3G mobile service, offered through the mobile operator core network 850. In another example, the femto node 810 can be operated by the mobile operator core network 850 to expand coverage of the wireless network. In addition, an access terminal 820 can be capable of operating both in macro environments and in smaller scale (e.g., residential) network environments. Thus, for example, depending on the current location of the access terminal 820, the access terminal 820 can be served by a macro cell access node 860 or by any one of a set of femto nodes 810 (e.g., the femto nodes 810A and 810B that reside within a corresponding user residence 830). For example, when a subscriber is outside his home, he is served by a standard macro cell access node (e.g., node 860) and when the subscriber is at home, he is served by a femto node (e.g., node 810A). Here, it should be appreciated that a femto node 810 can be backward compatible with existing access terminals 820.

A femto node 810 can be deployed on a single frequency or, in the alternative, on multiple frequencies. Depending on the particular configuration, the single frequency or one or more of the multiple frequencies can overlap with one or more frequencies used by a macro cell access node (e.g., node 860). In some aspects, an access terminal 820 can be configured to connect to a preferred femto node (e.g., the home femto node of the access terminal 820) whenever such connectivity is possible. For example, whenever the access terminal 820 is within the user's residence 830, it can communicate with the home femto node 810.

In some aspects, if the access terminal 820 operates within the mobile operator core network 850 but is not residing on its most preferred network (e.g., as defined in a preferred roaming list), the access terminal 820 can continue to search for the most preferred network (e.g., femto node 810) using a Better System Reselection (BSR), which can involve a periodic scanning of available systems to determine whether better systems are currently available, and subsequent efforts to associate with such preferred systems. Using an acquisition table entry (e.g., in a preferred roaming list), in one example, the access terminal 820 can limit the search for specific band and channel. For example, the search for the most preferred system can be repeated periodically. Upon discovery of a preferred femto node, such as femto node 810, the access terminal 820 selects the femto node 810 for camping within its coverage area.

A femto node can be restricted in some aspects. For example, a given femto node can only provide certain services to certain access terminals. In deployments with so-called restricted (or closed) association, a given access terminal can only be served by the macro cell mobile network and a defined set of femto nodes (e.g., the femto nodes 810 that reside within the corresponding user residence 830). In some implementations, a femto node can be restricted to not provide, for at least one access terminal, at least one of: signaling, data access, registration, paging, or service.

In some aspects, a restricted femto node (which can also be referred to as a Closed Subscriber Group H(e)NB) is one that provides service to a restricted provisioned set of access terminals. This set can be temporarily or permanently extended as necessary. In some aspects, a Closed Subscriber Group (CSG) can be defined as the set of access nodes (e.g., femto nodes) that share a common access control list of access terminals. A channel on which all femto nodes (or all restricted femto nodes) in a region operate can be referred to as a femto channel.

Various relationships can thus exist between a given femto node and a given access terminal. For example, from the perspective of an access terminal, an open femto node can refer to a femto node with no restricted association. A restricted femto node can refer to a femto node that is restricted in some manner (e.g., restricted for association and/or registration). A home femto node can refer to a femto node on which the access terminal is authorized to access and operate on. A guest femto node can refer to a femto node on which an access terminal is temporarily authorized to access or operate on. An alien femto node can refer to a femto node on which the access terminal is not authorized to access or operate on, except for perhaps emergency situations (e.g., 911 calls).

From a restricted femto node perspective, a home access terminal can refer to an access terminal that is authorized to access the restricted femto node. A guest access terminal can refer to an access terminal with temporary access to the restricted femto node. An alien access terminal can refer to an access terminal that does not have permission to access the restricted femto node, except for perhaps emergency situations, for example, 911 calls (e.g., an access terminal that does not have the credentials or permission to register with the restricted femto node).

For convenience, the disclosure herein describes various functionality in the context of a femto node. It should be appreciated, however, that a pico node can provide the same or similar functionality as a femto node, but for a larger coverage area. For example, a pico node can be restricted, a home pico node can be defined for a given access terminal, and so on.

A wireless multiple-access communication system can simultaneously support communication for multiple wireless access terminals. As mentioned above, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out system, a MIMO system, or some other type of system.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal In the alternative, the processor and the storage medium may reside as discrete components in a user terminal

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

1. A method for deploying a femto node with expanded coverage, comprising:
operating a femto node in an open or hybrid access mode to allow registration from both member and non-member devices;
monitoring conditions on a backhaul link maintained with a wireless network over a broadband connection configured to provide internet access to the devices and to other devices operating independent of the femto node; and
managing resources or mobility for each device based on whether the device is a member device or a non-member device and based on the conditions over on the backhaul link.

2. The method of claim 1, wherein managing the resources or mobility for each device comprises prioritizing resource allocation for member devices as compared to resource allocation for non-member devices when the conditions on the backhaul link fall below a threshold.

3. The method of claim 2, wherein prioritizing the resource allocation is further based on an airlink loading or a number of channel elements available at the femto node.

4. The method of claim 1, wherein managing the resources or mobility for each device comprises causing a non-member device to be handed over to another node when the conditions on the backhaul link fall below a threshold.

5. The method of claim 4, wherein causing the non-member device to be handed over is further based on whether the device is in an active call with the femto node and moving to the coverage area of the other node.

6. The method of claim 1, wherein managing the resources or mobility for each device comprises limiting resource allocation for the femto node over the broadband connection based on a throughput requirement for other internet traffic sharing the broadband connection.

7. The method of claim 1, further comprising detecting frequent handover of a device between the femto node and another femto node, wherein managing the resources or mobility for the device comprises causing the device to handover to a macro node based on the detected frequent handover.

8. The method of claim 1, wherein operating the femto node comprises allowing registration for at least one device located in a separate residence or outdoors as compared to the femto node, such that the expanded coverage provides coverage for both indoor and outdoor devices.

9. An apparatus for deploying a femto node with expanded coverage, comprising:
at least one processor configured to:
operate a femto node in an open or hybrid access mode to allow registration from both member and non-member devices,
monitor conditions on a backhaul link maintained with a wireless network over a broadband connection configured to provide internet access to the devices and to other devices operating independent of the femto node, and
manage resources or mobility for each device based on whether the device is a member device or a non-member device and based on the conditions over on the backhaul link; and
memory coupled to the at least one processor.

10. The apparatus of claim 9, wherein the at least one processor is configured to manage the resources or mobility for each device by prioritizing resource allocation for member devices as compared to resource allocation for non-member devices when the conditions on the backhaul link fall below a threshold.

11. The apparatus of claim 10, wherein prioritizing the resource allocation is further based on an airlink loading or a number of channel elements available at the femto node.

12. The apparatus of claim 9, wherein the at least one processor is configured to manage the resources or mobility for each device by causing a non-member device to be handed over to another node when the conditions on the backhaul link fall below a threshold.

13. The apparatus of claim 12, wherein causing the non-member device to be handed over is further based on whether the device is in an active call with the femto node and moving to the coverage area of the other node.

14. The apparatus of claim 9, wherein the at least one processor is configured to manage the resources or mobility for each device by limiting resource allocation for the femto node over the broadband connection based on a throughput requirement for other internet traffic sharing the broadband connection.

15. The apparatus of claim 9, wherein the at least one processor is further configured to detect frequent handover of a device between the femto node and another femto node, and wherein the at least one processor is configured to manage the resources or mobility for the device by causing the device to handover to a macro node based on the detected frequent handover.

16. The apparatus of claim 9, wherein the at least one processor is configured to operate the femto node by allowing registration for at least one device located in a separate residence or outdoors as compared to the femto node, such that the expanded coverage provides coverage for both indoor and outdoor devices.

17. An apparatus for deploying a femto node with expanded coverage, comprising:
means for operating a femto node in an open or hybrid access mode to allow registration from both member and non-member devices; means for monitoring conditions on a backhaul link maintained with a wireless network over a broadband connection configured to provide internet access to the devices and to other devices operating independent of the femto node; and
means for managing resources or mobility for each device based on whether the device is a member device or a non-member device and based on the conditions over on the backhaul link.

18. The apparatus of claim 17, wherein the means for managing the resources or mobility for each device comprises means for prioritizing resource allocation for member devices as compared to resource allocation for non-member devices when the conditions on the backhaul link fall below a threshold.

19. The apparatus of claim 18, wherein prioritizing the resource allocation is further based on an airlink loading or a number of channel elements available at the femto node.

20. The apparatus of claim 17, wherein the means for managing the resources or mobility for each device comprises means for causing a non-member device to be handed over to another node when the conditions on the backhaul link fall below a threshold.

21. The apparatus of claim 20, wherein causing the non-member device to be handed over is further based on whether the device is in an active call with the femto node and moving to the coverage area of the other node.

22. The apparatus of claim 17, wherein the means for managing the resources or mobility for each device comprises means for limiting resource allocation for the femto node over the broadband connection based on a throughput requirement for other internet traffic sharing the broadband connection.

23. The apparatus of claim 17, further comprising means for detecting frequent handover of a device between the femto node and another femto node, wherein the means for managing the resources or mobility for the device comprises means for causing the device to handover to a macro node based on the detected frequent handover.

24. The apparatus of claim 17, wherein the means for operating the femto node comprises means for allowing registration for at least one device located in a separate residence or outdoors as compared to the femto node, such that the expanded coverage provides coverage for both indoor and outdoor devices.

25. A non-transitory computer-readable medium comprising code, which, when executed by at least one processor, causes the at least one processor to perform operations for deploying a femto node with expanded coverage, the non-transitory computer-readable medium comprising:
code for operating a femto node in an open or hybrid access mode to allow registration from both member and non-member devices;
code for monitoring conditions on a backhaul link maintained with a wireless network over a broadband connection configured to provide internet access to the devices and to other devices operating independent of the femto node; and
code for managing resources or mobility for each device based on whether the device is a member device or a non-member device and based on the conditions over on the backhaul link.

26. The non-transitory computer-readable medium of claim 25, wherein the code for managing the resources or mobility for each device comprises code for prioritizing resource allocation for member devices as compared to resource allocation for non-member devices when the conditions on the backhaul link fall below a threshold.

27. The non-transitory computer-readable medium of claim 26, wherein prioritizing the resource allocation is further based on an airlink loading or a number of channel elements available at the femto node.

28. The non-transitory computer-readable medium of claim 25, wherein the code for managing the resources or mobility for each device comprises code for causing a non-member device to be handed over to another node when the conditions on the backhaul link fall below a threshold.

29. The non-transitory computer-readable medium of claim 28, wherein causing the non-member device to be handed over is further based on whether the device is in an active call with the femto node and moving to the coverage area of the other node.

30. The non-transitory computer-readable medium of claim 25, wherein the code for managing the resources or mobility for each device comprises code for limiting resource allocation for the femto node over the broadband connection based on a throughput requirement for other internet traffic sharing the broadband connection.

31. The non-transitory computer-readable medium of claim 25, further comprising code for detecting frequent handover of a device between the femto node and another femto node, wherein the code for managing the resources or mobility for the device comprises code for causing the device to handover to a macro node based on the detected frequent handover.

32. The non-transitory computer-readable medium of claim 25, wherein the code for operating the femto node comprises code for allowing registration for at least one device located in a separate residence or outdoors as compared to the femto node, such that the expanded coverage provides coverage for both indoor and outdoor devices.
